(19) United States
(12) Patent Application Publication
(10) Pub. No.: US 2012/0047344 A1
(43) Pub. Date: Feb. 23, 2012

(54) METHODS AND APPARATUSES FOR RE-ORDERING DATA

(76) Inventor: Gad S. Sheaffer, Haifa (IL)

(21) Appl. No.: 12/857,923

(22) Filed: Aug. 17, 2010

(51) Int. Cl. G06F 12/02

(52) U.S. Cl. 711/165; 711/E12.002

(57) ABSTRACT

Apparatuses and methods to perform data re-ordering are presented. In one embodiment, an apparatus comprises an input permutation unit, a multi-bank memory array, and an output permutation unit. The multi-bank memory array is coupled to receive data from the input permutation unit. The output permutation unit is coupled to receive data from the multi-bank memory array. The memory array comprises two or more memory rows. Each memory row comprises two or more memory elements.

### FIELD OF THE INVENTION

Embodiments of the invention relate to in computer systems; more particularly, embodiments of the invention relate to re-ordering data in arrays.

### BACKGROUND OF THE INVENTION

Newer software code is being generated to run on microprocessors as the computing technology advances. The types of instructions and operations supported by a microprocessor are also expanding. Certain types of instructions require more time to complete depending on the complexity of the instructions. For example, instructions that manipulate two-dimensional arrays via a series of micro-code operations result in longer execution than other types of instructions.

In addition, a common problem in processing data structures (e.g., one-dimensional arrays, linked lists, and two-dimensional arrays) is that the data are not stored in a format that is suitable for vector processing. For example, data that are organized in a two-dimensional array by rows are to be consumed by column (i.e., a transpose operation). Future software code will require even higher performance including the capability to execute instructions that manipulate two-dimensional arrays efficiently.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a data re-ordering apparatus.

FIG. 2 is a flow diagram of one embodiment of a process to perform data re-ordering.

FIG. 3 illustrates a computer system for use with one embodiment of the present invention.

FIG. 4 illustrates a point-to-point computer system for use with one embodiment of the invention.

### DETAILED DESCRIPTION OF THE INVENTION

Apparatuses and methods to perform data re-ordering are presented. In one embodiment, an apparatus comprises an input permutation unit, a multi-bank memory array, and an output permutation unit. The multi-bank memory array is coupled to receive data from the input permutation unit. The output permutation unit is coupled to receive data from the multi-bank memory array. The memory array comprises two or more memory rows. Each memory row comprises two or more memory elements.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

The method and apparatus described herein are for performing data re-ordering. Specifically, performing data re-ordering is primarily discussed in reference to multi-core processor computer systems. However, the method and apparatus for performing data re-ordering is not so limited, as they may be implemented on or in association with any integrated circuit device or system, such as cell phones, personal digital assistants, embedded controllers, mobile platforms, desktop platforms, and server platforms, as well as in conjunction with other resources, such as hardware/software threads.

### Overview

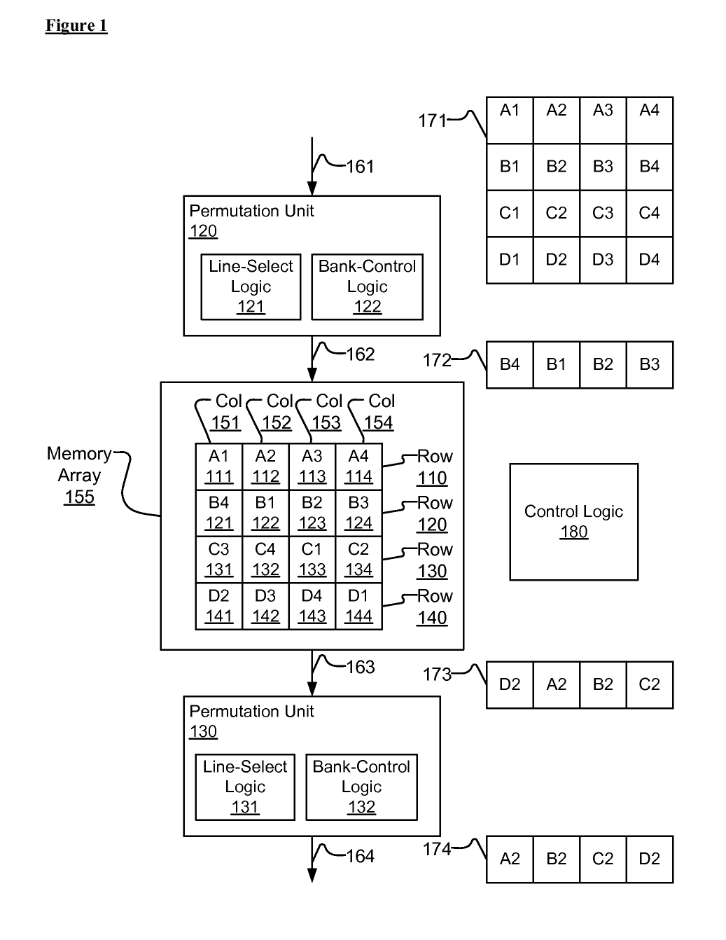

FIG. 1 is a block diagram of a data re-ordering apparatus. Many related components such as buses and peripherals have not been shown to avoid obscuring the invention. Referring to FIG. 1, in one embodiment, the data re-ordering apparatus comprises permutation unit 120, memory array 155, permutation unit 130, and control logic 180. In one embodiment, permutation unit 120 comprises line-select logic 121 and bank-control logic 122. Permutation unit 130 comprises line-select logic 131 and bank-control logic 132. Memory array 155 is coupled to permutation unit 120 and permutation unit 130.

In one embodiment, memory array 155 is operable to store data in the format of a two-dimensional array or a two-dimensional table. Memory array 155 is operable to store data representing a two dimensional table comprising rows and columns. In one embodiment, memory array 155 is to be loaded with the data for further processing. Data are loaded into memory array 155 in such a way that the data will then be read from memory array 155 without bank conflicts. In one embodiment, the data re-ordering apparatus permutes incoming data (e.g., data 161) before writing the data (e.g., data 162) into memory array 155. The data re-ordering apparatus reads data from multiple banks of memory array 155 and permutes the data (e.g., data 163) to produce outgoing data (e.g., data 164). In one embodiment, the permutation operations are rotate operations, for example to perform a matrix transpose operation.

In one embodiment, for example, memory array 155 comprises 4 memory rows (e.g., memory row 110, memory row 120, memory row 130, and memory row 140). Each memory row is divided into four banks (e.g., columns 151-154). Each bank holds a data element (e.g., 4 bytes each data element).

It will be appreciated by those skilled in the art that memory array 155 may be scaled up or down while maintaining approximately the same characteristic. For example, the mechanism described herein can be applied to an array having M memory rows. Each row comprises of N banks. Each bank holds K bytes of data. In one embodiment, M, N, and K are, for examples, integers that are of powers of two. Examples of some memory configurations include 4×4×16, 16×16×8, 64×64×16, and 256×256×8. In addition to that, a data element may be scalar floating point data, integer data, packed integer data, packed floating point data, or a combination thereof. The number of bytes of a data element may be scaled up or down (e.g., byte, word, and double words) in different embodiments.

In one embodiment, memory array 155 includes, but not limited to, memory registers, scalar integer registers, scalar floating point registers, packed single precision floating point registers, packed integer registers, a data cache, a register file, a part of a data cache, a part of a register file, or any combination thereof. In one embodiment, memory array 155 stores two-dimensional arrays in the memory registers, scalar integer registers, scalar floating point registers, packed single precision floating point registers, packed integer registers, a data cache, a register file, a part of a data cache, a part of a register file, or any combination thereof.

In one embodiment, permutation unit 120 is capable of performing a permutation operation, a rotation, a shuffle operation, a shift operation, or other data ordering operations. In one embodiment, for example, permutation unit 120 performs a rotation operation on a row of data comprising four data elements. In one embodiment, permutation 120 determines how many bytes (or data elements) to rotate and the direction of the rotation based on one or more parameters, the destination of the result (e.g., in which memory row the result of the rotation will be stored), or both.

In one embodiment, permutation unit 120 is operable to rotate a data row for a number of bytes (or data elements) in a direction before the data are sent to a memory row. The number of bytes (or data elements) to be rotated is based at least on to which memory row the rotation result is written in memory array 155.

In one embodiment, line-select logic 121 determines into which memory row the result of the rotation is written. In one embodiment, bank-control logic 122 determines which banks to select (e.g., which data element in a row to select) based on the type of an instruction. In one embodiment, line-select logic 121 and bank-control logic 122 generate control signals based on information inherent with an instruction, control information from control logic 180, one or more parameters in an instruction, or a combination thereof. In one embodiment, bank-control logic 132 determines which data element to be selected from a data row based at least on from where (e.g., the row number, the column number, or both) the data row is stored in the memory. Examples will be described in further detail below with additional references to FIG. 1.

In one embodiment, permutation unit 130 is capable of performing operations similar to permutation unit 120. In one embodiment, permutation unit 120 is referred to as an input permutation unit. Permutation unit 130 is referred to as an output permutation unit.

In one embodiment, permutation unit 130 reads a number of data elements. Each data element has been stored in a memory element from each of the memory rows. In one embodiment, permutation logic 130 rotates data from memory array 155 based on from which location (e.g., the row number, the column number, or both) the data have been stored in the memory array.

In one embodiment, control logic 180 sets the number of bytes to be rotated in one or more rotate operations based on the instruction type. In one embodiment, control logic 180 selects rows from memory array 155 and a memory element to be read from each of the selected rows.

### Operations

In one embodiment, for example, the data re-ordering apparatus supports an instruction to read a matrix (e.g., table 171) column wise (a transpose operation). In this example, the matrix comprises four data rows. Each data row includes four data elements where each data element is a single precision floating point value (4 bytes). The operations include loading data into memory array 155 and then reading data from memory array 155.

In one embodiment, a loading instruction on table 171 (a 4×4 two-dimensional data) includes the following operations (not limited to any specific order):

(1) Load four data elements from the first row of the table 171 into row 110, without a rotate operation;

(2) Rotate data elements from the second row of table 171 to the right by 4 bytes; load the result of the rotation to row 120; Refer to example, data 172 which shows “B4, B1, B2, B3”;

(3) Rotate data elements from the third row of table 171 to the right by 8 bytes; load the result of the rotation to row 130; and

(4) Rotate data elements from the fourth row of table 171 to the right by 12 bytes; load the result of the rotation to row 140.

In one embodiment, memory array 155 comprises 4 banks in each memory row. In one clock cycle, a data element from one bank (from each memory row) is driven onto the corresponding output bank. In one embodiment, a reading instruction includes the following operations (not limited to any specific order):

(5) A1, B1, C1, and D1 are read from 4 different banks and become data 163; data 163 is sent to output (e.g., outgoing data 164) without a rotation;

(6) D2, A2, B2, and C2 are read from 4 different banks and become data 163; data 163 are rotated to the left for 4 bytes (one data element) and become A2, B2, C2, D2 at outgoing data 164; Refer to the example, data 173 showing “D2, A2, B2, C2” and data 174 showing “A2, B2, C2, D2” after the rotation.

(7) C3, D3, A3, and B3 are read from 4 different banks to become data 163. Data 163 are rotated to the left for 8 bytes (two data elements) and become A3, B3, C3, D3 at outgoing data 164; and

(8) B4, C4, D4, and A4, are read from 4 different banks (as the output at data 163). Data 163 are rotated to the left for 12 bytes (three data elements) and become A4, B4, C4, D4 at outgoing data 164.

It will be appreciated by those skilled in the art that a rotate operation may be performed by rotating data to the left or to the right depending on the number of bytes that is rotated. For example, a 4-byte right rotation is similar to 12-byte left rotation in the above example. In one embodiment, operations 5-8 is performed in a clock cycle each.

In other embodiment, memory array 155 is used to provide a more generic functionality. Control logic 180 provides information (parameters) to permutation unit 120, permutation unit 130, or both, including information on bank selection. It will be appreciated by those skilled in the art that an instruction may includes one or more parameters which set the type of a permutation operation, the number of bytes to be rotated if the permutation operation is a rotation operation, the destination memory row, or any combination thereof.

In one embodiment, permutation unit 120 does not perform rotation if the data is from the first row of a table. In one embodiment, permutation unit 130 does not perform rotation if the data is from the first column of data stored in memory array 155.

In one embodiment, permutation unit 120 is capable of performing a generic permutation function that moves any byte (being written) to any location in the line (being written) in memory array 155. In one embodiment, permutation 130 is capable of performing a generic permutation function that moves any byte on the multi-banked output (data 163) of memory array 155 to any location in the outgoing data 164.

In one embodiment, to perform scatter operations, another memory array similar to the organization of memory array 155 is used. In another embodiment, memory array 155 is used to perform scatter operations and gather operations if each data port of memory array 155 is a read/write port.

In one embodiment, memory array 155 is formed with a group of registers in a register file. In one embodiment, for example, a 16×16 data array is loaded into memory array 155 formed with a register file that includes 32 registers. In this example, 16 registers in the register file will be used to store data elements from the 16×16 data array. For instance, register 17 is used to store data from row 6 of the data array. As a result, register 17 is associated with row number 6 (index 6). Consequently, an instruction (e.g., a read instruction, an ADD instruction, etc.) that reads from register 17 will yield data from column 6 of the data array, in conjunction with the operations of permutation units 120 and 130. In one embodiment, a load instruction that load data elements into memory array 155 includes parameters, such as, for examples, an memory address, the register number (e.g., register 17), the row number in memory array (e.g., row 6 of memory array 155). In one embodiment, memory array 155 includes memory structures to store the associations (mapping) between the row numbers and the register numbers.

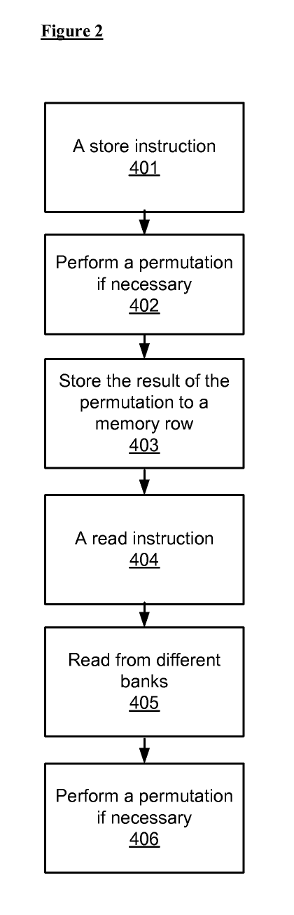

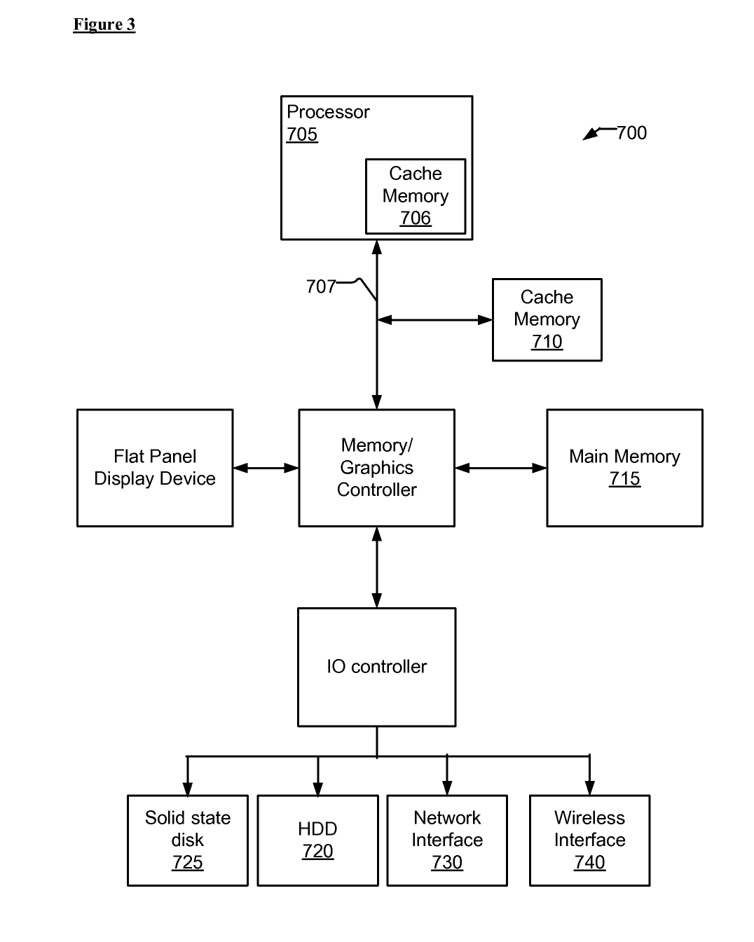

FIG. 2 is a flow diagram of one embodiment of a process to perform data re-ordering. The process is performed by processing logic that may comprise hardware (circuitry, dedicated logic, etc.), software (such as is run on a general purpose computer system or a dedicated machine), or a combination of both. In one embodiment, the process is performed in conjunction with memory array (e.g., memory array 155 with respect to FIG. 1). In one embodiment, the process is performed by a computer system with respect to FIG. 3.

In one embodiment, processing logic receives incoming data in response to an instruction (process block 401), for example, a store instruction, a pre-load instruction, or a gather instruction. In one embodiment, processing logic determines whether to perform one or more permutation operations on the incoming data. In one embodiment, the incoming data is in the form of a two-dimensional array which comprises a number of rows and columns. In one embodiment, processing logic performs a permutation operation on a row of data based at least on to which memory row the row of data will be stored (process block 402).

In one embodiment, processing logic stores the results of a permutation operation to a memory array (process block 403). It will be appreciated by those skilled in the art that an instruction may includes one or more parameters which set the type of a permutation operation, the number of bytes to be rotated if the permutation operation is a rotation operation, the destination memory row, or any combination thereof.

In one embodiment, processing logic reads data from a number of different memory banks in response to an instruction, for example, a read instruction or a scatter instruction (process blocks 404-405). In one embodiment, processing logic determines whether to perform one or more permutation operations on outgoing data from a memory array (process block 405). In one embodiment, processing logic the outgoing data is in the form of a two-dimensional array which comprises a number of rows and columns. In one embodiment, processing logic performs a permutation operation on a row of the outgoing data based at least on from where (e.g., the row number, the column number, or both) the data are loaded.

Embodiments of the invention may be implemented in a variety of electronic devices and logic circuits. Furthermore, devices or circuits that include embodiments of the invention may be included within a variety of computer systems. Embodiments of the invention may also be included in other computer system topologies and architectures.

FIG. 3, for example, illustrates a computer system in conjunction with one embodiment of the invention. Processor 705 accesses data from level 1 (L1) cache memory 706, level 2 (L2) cache memory 710, and main memory 715. In other embodiments of the invention, cache memory 706 may be a multi-level cache memory comprise of an L1 cache together with other memory such as an L2 cache within a computer system memory hierarchy and cache memory 710 are the subsequent lower level cache memory such as an L3 cache or more multi-level cache. Furthermore, in other embodiments, the computer system may have cache memory 710 as a shared cache for more than one processor core.

In one embodiment, the computer system includes quality of service (QoS) controller 750. In one embodiment, Qos controller 750 is coupled to processor 705 and cache memory 710. In one embodiment, QoS controller 750 regulates cache occupancy rates of different program classes to control resource contention to shared resources. In one embodiment, QoS controller 750 includes logic such as, for example, PI controller 120, comparison logic 170, or any combinations thereof with respect to FIG. 1. In one embodiment, QoS controller 750 receives data from monitoring logic (not shown) with respect to performance of cache occupancy, power, resources, etc.

Processor 705 may have any number of processing cores. Other embodiments of the invention, however, may be implemented within other devices within the system or distributed throughout the system in hardware, software, or some combination thereof.

Main memory 715 may be implemented in various memory sources, such as dynamic random-access memory (DRAM), hard disk drive (HDD) 720, solid state disk 725 based on NVRAM technology, or a memory source located remotely from the computer system via network interface 730 or via wireless interface 740 containing various storage devices and technologies. The cache memory may be located either within the processor or in close proximity to the processor, such as on the processor's local bus 707. Furthermore, the cache memory may contain relatively fast memory cells, such as a six-transistor (6T) cell, or other memory cell of approximately equal or faster access speed.

Other embodiments of the invention, however, may exist in other circuits, logic units, or devices within the system of FIG. 3. Furthermore, in other embodiments of the invention may be distributed throughout several circuits, logic units, or devices illustrated in FIG. 3.

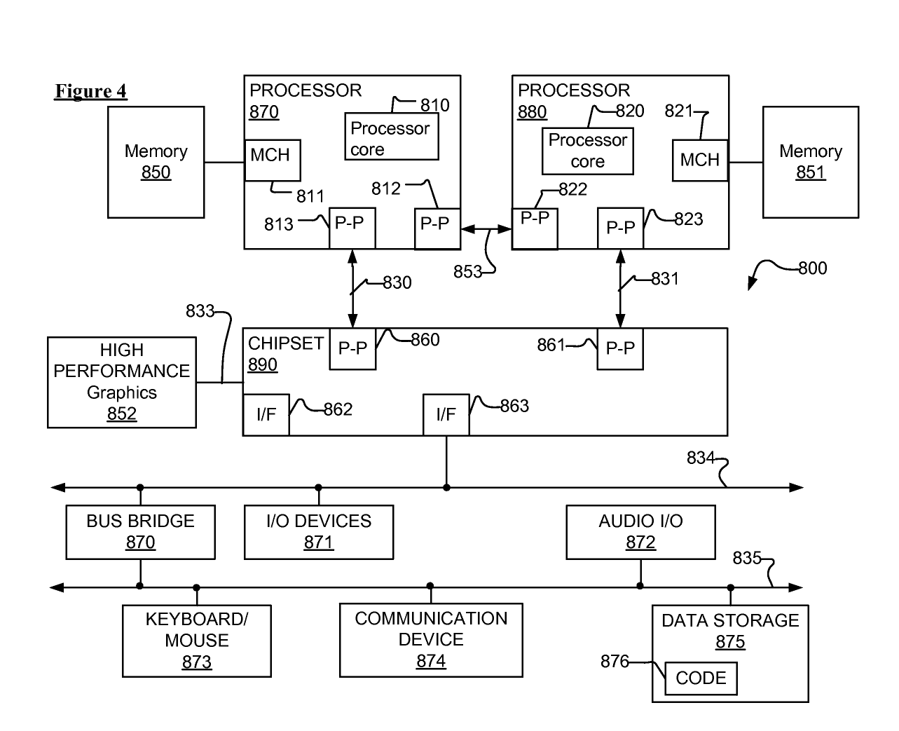

Similarly, at least one embodiment may be implemented within a point-to-point computer system. FIG. 4, for example, illustrates a computer system that is arranged in a point-to-point (PtP) configuration. In particular, FIG. 4 shows a system where processors, memory, and input/output devices are interconnected by a number of point-to-point interfaces.

The system of FIG. 4 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be coupled to computer bus (834 or 835), or within chipset 890, or coupled to data storage 875, or coupled to memory 850 of FIG. 4.

Other embodiments of the invention, however, may exist in other circuits, logic units, or devices within the system of FIG. 4. Furthermore, in other embodiments of the invention may be distributed throughout several circuits, logic units, or devices illustrated in FIG. 4.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. An apparatus comprising a processor operable to perform one or more vector operations, wherein the processor comprises
a first permutation unit;
a multi-bank memory array to receive first data from the first permutation unit; and
a second permutation unit to receive second data from the multi-bank memory array, wherein the first permutation unit and the second permutation unit are operable to rotate the first data and the second data respectively.

2. The processor of claim 1, wherein the memory array comprises a plurality of memory rows, each memory row comprises two or more memory elements.

3. The processor of claim 2, wherein the first permutation unit is operable to rotate, for a first number of bytes in a first direction, the first data before the first data are sent to a first memory row, wherein the second permutation unit is operable to rotate, for a second number of bytes in a second direction, the second data from the memory array, wherein the first number and the second number are the same but the first direction and the second direction are opposite.

4. The processor of claim 2, wherein the memory array is operable to store data representing a two dimensional table comprising rows and columns.

5. The processor of claim 2, wherein the processor is operable to store, in response to a store instruction, a first plurality of data elements to a first memory row of the memory array, wherein the processor is operable to read a second plurality of data elements in response to a read instruction, each of the second plurality of data elements is stored in a memory element of each of the plurality of memory rows.

6. The processor of claim 2, wherein the first permutation unit is operable to rotate, for a number of data elements in a direction, a plurality of data elements before the plurality data elements are sent to the memory array.

7. The processor of claim 2, wherein the second permutation unit is operable to rotate, for a number of data elements in a direction, a plurality of data elements from the memory array before sending out the plurality of data elements.

8. The processor of claim 2, wherein the second permutation unit is operable to rotate the second data from the memory array based at least on from where the second data are stored in the memory array.

9. The processor of claim 2, further comprising control logic to set, in response to an instruction, at least the number of bytes to be rotated in one or more rotate operations.

10. The processor of claim 2, further comprising control logic operable to select one or more rows from the memory array in response to a read instruction, a memory element is read from each of the one or more rows.

11. A method comprising:
storing, in response to a first instruction, a result of a first rotate operation on a first plurality of data elements to a first memory row of a memory array; and
storing, in response to the first instruction, a result of a second rotate operation on a second plurality of data elements to a second memory row of the memory array.

12. The method of claim 11, further comprising loading a third plurality of data elements in response to a read instruction, each of the third plurality of data elements is stored in a memory element of each of a plurality of memory rows in the memory array.

13. The method of claim 11, wherein in response to the first instruction, one or more results from a first plurality of rotate operations are stored to one or more memory rows of the memory array.

14. The method of claim 11, wherein the memory array comprises two or more memory rows, each memory row comprises a plurality of memory elements.

15. The method of claim 11, wherein the number of bytes to be rotated in the second rotation is based at least on to which memory row the result is written in the memory array.

16. A system comprising:
a memory;
permutation logic coupled to the memory;
a processing unit coupled to the permutation logic such that the permutation logic performs a first permutation operation on data to be loaded into the memory.

17. The system of claim 16, wherein the memory is operable to store a plurality of data rows, each data row comprising a plurality of data elements.

18. The system of claim 16, wherein the permutation logic is operable to perform a rotate operation on data elements, wherein the permutation logic further comprises line-select logic operable to determine which row to store the data elements into the memory after the rotate operation.

19. The system of claim 16, wherein the permutation logic further comprises bank-control logic operable to determine which data element to be selected from a data row based at least on where the data row is stored in the memory.
